(19) United States
(12) Patent Application Publication
(10) Pub. No.: US 2003/0065521 A1
(43) Pub. Date: Apr. 3, 2003

(54) Method for building a marketing data knowledge base

(76) Inventor: Diana Goodwin, Meridan, ID (US)

Correspondence Address: HEWLETT-PACKARD COMPANY, c/o Matthew L. Wade, Intellectual Property Administration, P.O. Box 272400, Fort Collins, CO, 80527-2400, US

(21) Appl. No.: 09/968,087

(22) Filed: Oct. 1, 2001

(51) Int. Cl. G06F 17/60

(52) U.S. Cl. 705/1

(57) ABSTRACT

A method for building a marketing knowledge base has steps of directing all marketing data requests form a business organization through a central marketing research resource that has a collective knowledge base. If the central resource can address the requested data by reference to the collective knowledge base it does so and reports the desired data. If the collective knowledge base will not allow for addressing the request, the central resource develops the data using an outside source. Once developed, the data is added to the central resource and reported.

### FIELD OF THE INVENTION

The present invention is related to methods for building a knowledge base. More particularly, the present invention is related to methods for business organizations to continually build a marketing knowledge base.

### BACKGROUND OF THE INVENTION

Businesses organizations rely on marketing data for a variety of mission critical purposes. Having reliable marketing data has become important to a business organization's success as the pace of the marketplace has increased, markets have expanded to international scope, and as customers have become more demanding. Marketing data may comprise quantitative research that is generally based on polling and includes numerical results, or qualitative research that is more subjective and relates more to customer opinion non-quantifiable data than to numerical data. That is, the qualitative data may be thought of as relating to customer “likes and dis-likes” that are difficult to numerically characterize. These data may be used internally by a business for a wide variety of purposes, such as for allocating product development resources for future products.

Businesses obtain marketing data through one of several methods. In many organizations, a specific marketing data need is presented to a market research professional. The market research professional will then take various steps as required to gather and analyze market data to address the marketing data need. Obtaining the data may be achieved generally through using internal resources, external resources, or a combination of both. Often, external resources are relied upon at least in part. Indeed, an entire industry has emerged dedicated to providing market research to businesses. External resources and information vendors may be used with expertise in a wide variety of business and market areas. Advantageously, use of such consultants provides access to tools and skills for measuring market preference that may not exist internal to the business.

However obtained, once a current marketing data need has been addressed, the internal and or external market researchers will move on to the next data need as required. Although this practice generally results in addressing the specific current marketing data need, there are several disadvantages associated with it. By way of example, the obtained data may not be available in a useful format for further exploration or for future reference. That is, dissemination of the obtained marketing data beyond the particular requester to additional personnel may be limited. Also, all of the data may not be utilized. For example, a great deal of data may be developed with only a portion used that addresses a very specific need. This can result in costly duplicative or overlapping research being conducted by different requesters within a business.

As a proposed solution to this problem, depositories have been used for the obtained marketing data. These depositories often take the form of computer-based databases available for access over a network. In practice, however, such solutions have achieved only limited success. It has been found that effective organization of the depositories is difficult, with the result that only very specific data are available in a haphazardly organized manner. Also, use of the depositories may require sifting through literally thousands of entries with the result that these depositories are often not a time-effective option. These and other factors have made it difficult to develop trends or to otherwise fully utilize the information gathered.

Use of external resources such as consultants also suffers from numerous disadvantages, however. As a first, use of external resources often does little to address problems associated with dissemination of the resultant information internal to the business. That is, generally the consultant is presented with a specific task and responds with a narrowly tailored report and/or presentation. Once obtained, it may be difficult to widely disseminate the information contained in the report and presentation. Also, it has proven difficult for many business organizations to integrate information obtained in such a manner from an external resource with similar information obtained from other consultants over time to develop broad trends. Much like the situation that exists with haphazardly conducted internal research, this may result in duplicative or overlapping efforts being commissioned.

Additionally, there are disadvantages associated with use of consultants as a result of their separation from the business. Consultants offer their skills and resources to a variety of customers, including competitors of the business. Even though the consultant may treat each particular assignment as confidential, each individual assignment may be performed in a like manner, using the same theories, models, resources and practices, with the result that similar insights and conclusions tend to be developed. As a result, use of external resources may make it more difficult for a business to build a competitive advantage over competitors.

Also, external resources generally operate with a business model that encourages multiple projects of limited duration to address specific tasks. This may result in these specific tasks being addressed in a timely manner, but the resultant information may be so specific that it does not lend itself well to a broader application. Finally, use of external resources and information vendors tends to be costly and time consuming. It is not uncommon for quantitative research marketing research projects to take upwards of 1 to 2 years when conducted via external resources.

Unresolved problems in the art therefore exist.

### SUMMARY OF THE INVENTION

The present invention is drawn to a method for continually building a marketing knowledge base within a business organization. One embodiment of the method comprises steps of identifying desired marketing data and channeling a request for the desired data to a central marketing research resource within the business organization that has a collective marketing knowledge base. The central resource then determines whether the desired data is within its collective knowledge base. If it is not, the central resource will develop the data, report it, and add it to the collective knowledge base for future use.

As used herein, the term “collective knowledge base” is intended to broadly refer to a set of data that comprises at least a “human element” to it. That is, the collective knowledge base comprises a data set at least a portion of which is retained within an individual's, such as analysts' personal knowledge. Further, this human element of data may be referred to herein as “intellectual capital,” with the result that as used herein a collective knowledge base comprises at least intellectual capital. By way of further definition, “intellectual capital” may be considered to be the collective set of skills, abilities, knowledge, and the like embodied in a single or a group of employees.

Preferably, the business organization comprises a plurality of units, groups, or the like for marketing to a corresponding plurality of markets, and each of the groups channels its marketing data requests through the central marketing resource. The central resource also preferably comprises an analyst group staffed with professional marketing analysts, at least some of whom have a background in statistics.

It will be appreciated that methods of the invention helps solve many otherwise unresolved problems in the art. For example, because marketing data requests can be channeled through a central marketing research resource, the central resource has an opportunity to continually build a comprehensive knowledge base. This channeling through a central resource can improve data dissemination and reduce occurrences of duplicative or overlapping data development. Additionally, cost and time savings may be accomplished as the central resource collective knowledge base is more extensive and better accessed than in many methods of the prior art. Further, increased use of an in-house resource allows for a business organization to build a knowledge base that is not available to its competitors, and to thereby gain competitive advantages.

The above brief description sets forth broadly some of the more important features and advantages of the present disclosure so that the detailed description that follows may be better understood, and so that the present contributions to the art may be better appreciated. There are, of course, additional features of the disclosure that will be described hereinafter that form the subject matter of the claims appended hereto. In this respect, before explaining an embodiment of the disclosure in detail, it is to be understood that the disclosure is not limited in its application to the details of the construction set forth in the following description or illustrated in the drawings. The present invention may provide additional embodiments, as will be appreciated by those knowledgeable in the art. Also, it is to be understood that the phraseology and terminology employed herein are for description and not limitation.

### BRIEF DESCRIPTION OF THE DRAWINGS

FIG. 1 is a schematic useful in illustrating a prior art method.

FIG. 2 is a schematic useful for illustration of a method embodiment of the invention.

FIG. 3 is a flow chart illustrating steps of a method embodiment of the invention.

### DETAILED DESCRIPTION

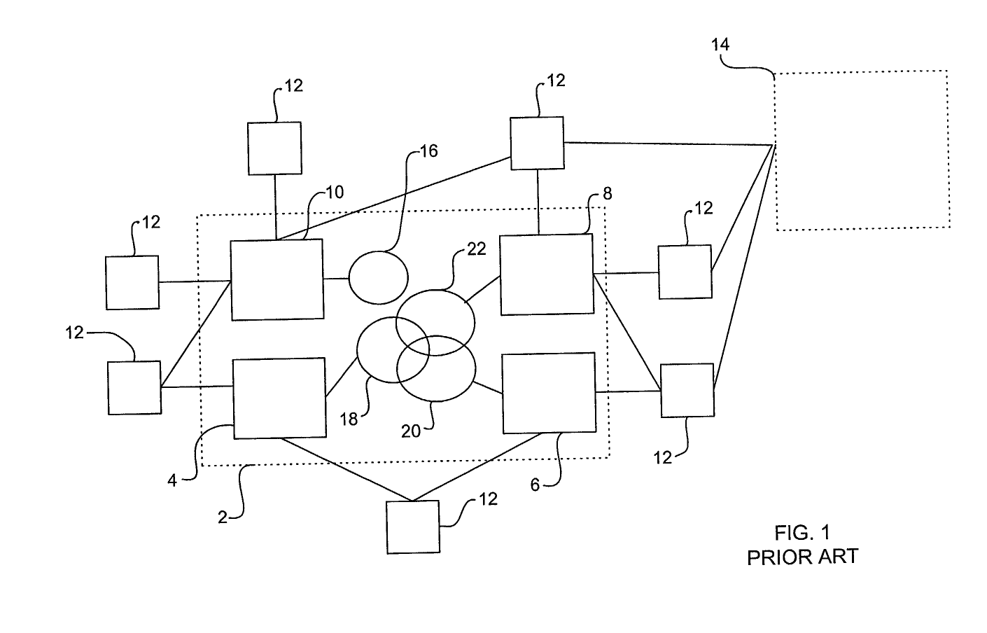

In describing an embodiment of the method of the invention in detail, it will be helpful to first discuss a method of the prior art. Accordingly, FIG. 1 is a schematic diagram useful in describing a prior art method for building a marketing knowledge base. In general, a business organization such as a corporation represented as the dashed line box 2 has a plurality of individual business units represented by the individual boxes 4, 6, 8 and 10. As used herein, the term “business organization” is intended to broadly refer to any legal entity such as a corporation, partnership, or the like for conducting a business, while the term “business unit” is intended to broadly refer to an organizational unit, group, or the like within a larger business organization. By way of example, business units 4-10 may comprise individuals, divisions, companies, facilities, or the like. By way of further example, the units 4-10 may comprise different groups for marketing products to different geographical regions; different groups marketing similar products to the same region; groups having different functions such as manufacturing, marketing, research, accounting; or the like.

Under methods of the prior art, each of the individual units 4-10 may use one or more external resources 12 to address marketing data needs. As used herein, the term “external resource” is intended to refer to an entity external to the business organization. By way of example, an external resource may comprise for instance a consultant, a consulting company, an information or data vendor, an advertising company, or the like, with a useful example comprising a marketing consultant. The consultants may then design a study, execute the study, organize the results, and present the results to the business unit. As illustrated by the solid lines in FIG. 1 that connect several of the business units 4-10 to several of the external resources 12, each business unit may use a plurality of the resources 12. Additionally, the resources 12 may provide services to other corporations, with an example illustrated in FIG. 1 by dashed box 14. Because each of the business units works directly with a plurality of external resources, market data tasks may be duplicated or overlap.

Following presentation of the marketing data from the outside resource 12, the business units 4-10 may place the data in some form of a data repository for future reference. An example is illustrated in FIG. 1 by the business unit 10 having a repository illustrated as circle 16 for storing obtained marketing data. As illustrated by FIG. 1, however, the business unit 10 marketing data repository is not available to other of the business units 4-8.

As an alternative, the prior art has attempted to make marketing data more widely available through creating repositories accessible to a plurality of business units. This is illustrated in FIG. 1 through the business units 4, 6, and 8 by attempting to place their repositories, illustrated by circles 18, 20, and 22, respectively, in a commonly accessible manner. As further illustrated by FIG. 1, however, such efforts have achieved only limited success. In practice only the intersecting portions of the data sets 18, 20, and 22 may be available to all of the participating business units 4-8. This may be a result of a variety of reasons generally discussed herein above, with examples including a haphazard and inconsistent approach to formatting and storing the marketing data that results from the data being obtained and deposited by the different units 4-8. As a second example, a “human element” of the data that may be required to fully understand the data may reside only in a few individuals that are not accessible through the repositories.

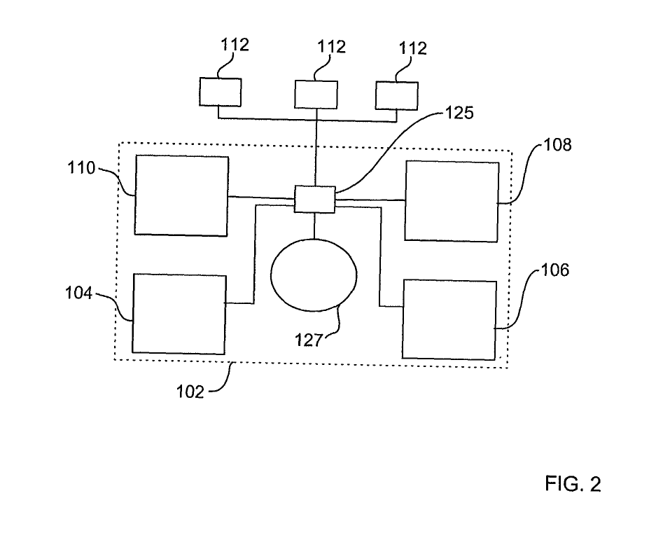

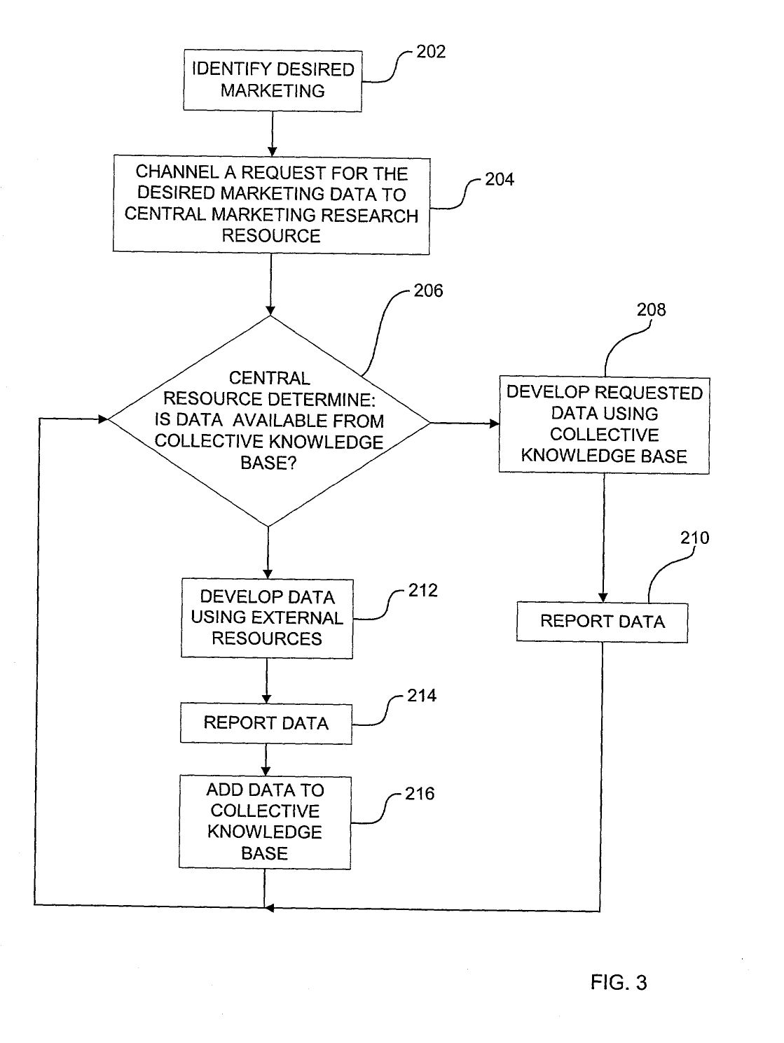

In the context of this example of prior art practice, the present invention may now be better understood. Accordingly, reference is now made to the schematic of FIG. 2 as well as the flowchart of FIG. 3 useful for describing an embodiment of a method of the invention in detail. The schematic of FIG. 2 illustrates a corporation 102 having a plurality of individual business units 104-110. A method embodiment of the invention begins by any of the business units 104-110 identifying desired marketing data (block 202).

Preferably, the desired marketing data comprises quantitative data. The term “quantitative data” as used herein is intended to refer to data that may be expressed in numerical terms. By way of example, quantitative marketing data may comprise data that may be determined regarding customer behavior, customer satisfaction, and the like that is determined through execution of research surveys, polling, or the like. Other examples of quantitative marketing data may likewise comprise market share portions expressed in units of percentage, dollars, or the like; may comprise market size in terms of sales volume in units of products or dollars; may comprise consumer market data; or may comprise other like data. Embodiments of the method of the invention may likewise be practiced using other forms of data in addition to quantitative marketing data.

By way of still further example, desired marketing data may comprise the size of the market for a computer peripheral printer with a retail cost of $250 in Spain, as well as the number of those customers that would be willing to pay an additional $50 for color scanning capabilities on their printers. Such a request may originate from a business group charged with marketing responsibilities for Europe, which may by way of example comprise the business unit 104 of FIG. 2.

Through a step of an embodiment of the invention, such a request for data is channeled to a central marketing resource 125 (block 204). The term “central marketing resource group” as used herein is intended to refer to a organizational unit, group, or the like within a larger business organization that is charged with a marketing research function. Preferably, a central marketing resource comprises at least a plurality of professional analysts, with at least some of the analysts having at least five years employment experience with the corporation. Most preferably, the group is comprised of professional analysts having an average amount of experience of five years or more with the business corporation. The term “professional analyst” is intended to refer to an individual who has held a full time position with duties including analysis. It is theorized that five years employment experience with the corporation results in a good level of knowledge of the corporation's markets, products, and practices. Also, at least one of the plurality of analysts preferably has a statistical educational background. As used herein, the term “statistical educational background” is intended to refer to a graduate or undergraduate degree with a major or minor in math, statistics, or economics.

The central marketing resource has a collective knowledge base, which is represented in FIG. 1 by the circle 127. As discussed above, the term “collective knowledge base” as used herein is intended to broadly refer to a set of data that comprises at least an element of human knowledge or “intellectual capital.” A collective knowledge base may further comprise a digital database, a collection of written records, or the like, in addition to intellectual capital. Preferably, the collective knowledge base 127 represents substantial intellectual capital. The collective knowledge base, in fact, may be comprised entirely of intellectual capital.

A preferred collective knowledge base 127 comprises a combination of written data, digital data and intellectual capital. Written and digital data elements of the collective knowledge base may comprise results of previous quantitative marketing research projects, published papers and articles concerning marketing trends and studies, and the like. The intellectual capital may comprise not only the knowledge of the content and organization of the written and digital element, but also the sum total of the analysts' educational and professional experience.

Once the central marketing research resource 125 is presented with the request for desired marketing data, the method embodiment comprises a step of making a determination of whether the request may be addressed through reference to the collective knowledge base 127 (block 206). That is, the central resource 125 examines the request for data and determines whether it has the ability to provide the requested data using the resources of the collective knowledge base 127. If so, steps are comprised of the central resource developing the requested data (block 208) using the collective knowledge base, and of reporting the data (block 210). The term “develop” when used in reference to data herein is intended to broadly refer to acts related to obtaining data. By way of example, to develop data may comprise designing a study to obtain the data, reviewing the results of the study, and formatting the resultant data for presentation.

By way of additional example, a method embodiment may comprise steps of the central resource 125 developing the requested data by reviewing written and digital data from previous marketing projects that were not directed to the particular data request but were directed to related requests. The analysts may then further add an element of their personal knowledge of the field to extrapolate the data from the previous studies to the current request. The analysts may then tailor a report directed to the current request using these assembled written, digital, and personal knowledge components and report it.

If the central resource 125 determines that the requested data cannot be developed using the collective knowledge base 127, the central resource 125 may utilize an external resource to develop all or part of the data (block 212). External resources have been illustrated as boxes 112 in FIG. 2, and may represent a variety of resources. By way of example, they may represent entities external to the corporation 102 identical or similar in function to the resources 12 of FIG. 1. That is, they may represent marketing, market research consultants, information or data vendors, or the like for obtaining desired quantitative or qualitative marketing research through surveying or-the like.

Once developed, the external data is reported (block 214). It will be appreciated that the central resource may use one or more external resources 112, with no limitation on the number used other than what may be practical. Three external resources 112 have been illustrated in FIG. 2 for convenience. It will also be appreciated, however, that an advantage of the present invention is that it may result in use of fewer external resources 112 than were required using some prior art methods as a result of the step of channeling substantially all data requests through the central research resource 125. It will also be appreciated that the externally developed data may comprise only a portion of the requested and reported data. That is, the central resource 125 may determine, for instance, that the requested data is partially but not completely available using the collective knowledge base 127. Under such circumstances, embodiments of the method of the invention may comprise the central resource 125 using the external resources 112 in a limited capacity to develop only the portion of the data that is not available from the collective knowledge base 127 using the external resources 112.

After the external resource 112 has developed the data, the method embodiment comprises a step of the central resource 125 adding the data to the collective knowledge base 127. This may comprise adding the data in written, digital, human knowledge, or other form to the collective knowledge base 127. As the collective knowledge base comprises at least an intellectual capital portion, adding the data to the collective knowledge base comprises at least adding a portion of the data to the intellectual capital. By way of example, a written and digital report may be filed for storage and further development and access, with the analysts' personal knowledge also being added to through exposure and review of the data. In this manner it will be appreciated that embodiments of the method of the invention lead to continual growth of a collective knowledge base.

It will also be appreciated that embodiments of the invention also lead to many additional benefits and solve many otherwise unresolved problems in the art. For example, method embodiments comprise channeling all data requests from all business units 104-110 through the central resource 125. The central resource thereby is able to participate in substantially all of the marketing data requests of the corporation 102, and to thereby gain an extensive and intimate collective knowledge base 127 regarding the corporation's markets and businesses that may have been more scattered and haphazardly organized using some methods of the prior art.

The central resource may be able to detect trends through recurring themes of the requested data, with the trends becoming part of the collective knowledge base for access by the corporation. These trends may have been much more difficult or impossible to discern under many method of the prior art where data requests were processed by a plurality of groups not in good communication with one another. Also, because the central resource 125 handles all data requests, the central resource 125 may therefore be able to combine multiple requests into a single project that enjoys decreased cost and delivery time due to economies of scale. The corporation 102 is therefore able to maintain a control and awareness of the collective knowledge base than was not possible under many methods of the prior art. This can lead to additional benefits.

For example, the methods of the invention may offer additional competitive advantages over some methods of the prior art. For example, embodiments of the present invention may lead to less dependence on outside resources 112. In addition to cost and time savings, this may also result in developing a competitive advantage over competitors that have a heavier reliance on external resources 112. For example, because the outside resources 112 may tend to provide the same or at least similar data, they may be difficult to utilize for obtaining a unique marketing perspective. The internal central resource 125, however, will be able to develop a perspective contained in the collective knowledge base 127 that is much easier to maintain as proprietary and secret from competitors. In a sense, the method of the invention thus shifts strategic data content from the external resources 112 into the proprietary bounds of the corporation 102.

These and other advantages of embodiments of the present invention may be appreciated through a comparison of FIG. 1's prior art schematic with the schematic of FIG. 2. For example, it will be appreciated that the collective knowledge base 127 is accessible in whole to all of the business units 104-110 through the central resource 125 in contrast to the only partially intersecting data repositories 16-22 that are accordingly only partially available to the individual business units 4-10. In addition, the multiple relationships existing between the individual business units 4-10 and external resources 12 have been replaced with relationships with outside resources 112 flowing through the central resource 125. These and other features of the current invention provide cost and time savings through reducing or eliminating duplicated and/or overlapping data development.

An embodiment of the present invention, as well as some of its advantages, may be further explained through an illustrative example. Assume for instance that the corporation 102 of FIG. 2 is in the business of selling computer peripherals, and that the business unit 104 is charged with marketing products to Western Europe. In order to determine how many new computer color printers specially adapted for use with laptop computers to manufacture, the corporation 102 needs to estimate how many of the printers it will sell in Western Europe in the next eighteen months. Under methods of the prior art, the business unit 4 of FIG. 1 may refer to the data repository 18 to learn that this data is not available, and resultantly request the outside resource 12 to develop the data. The resource 12 may in turn design a survey, execute the survey, organize the results, and present them to the business unit 4. This process may have considerable time and expense associated with it.

Under an embodiment of the present invention, on the other hand, the data request will be channeled from the business unit 104 to the central resource 125. An experienced analyst in the central resource 125 may determine from the collective knowledge base 127 that the precise requested data is not available, but that the collective knowledge base 127 contains data indicating that the general printer buying trends of Western Europe closely mirror those of the United States with a lag time of about six months, and that Western European printer buying trends typically exceed those of Eastern Europe by a factor of three. This knowledge may be in the collective knowledge base 127 in the form of the analyst's personal knowledge built through many years of studying printer buying trends.

The analyst may further determine from the collective knowledge base that sales estimates have already been created for the particular printer for Eastern Europe and for the United States as a result of data requests received by the central resource 125 from others of the business units 106-110. The analyst may then develop a sales forecast using these two data points and his knowledge of how the data points relate to Western European sales. These data may then be presented in a much more timely and less costly manner to the business unit 104 than was possible under some methods of the prior art.

By way of further example, if the relationships between Western Europe, Eastern Europe, and the United States were somewhat tenuous and greater confidence was desired, the analyst from the central resource 125 could use an external resource 112 to confirm the developed data. Because data had already been developed, however, the scope of the project presented to the external resource 112 may be significantly smaller in scope than under methods of the prior art, and thereby achieve cost and time savings over those methods. The confirmation or rebuttal of the relationship as well as the underlying data obtained from the external resource 112 would be added to the collective knowledge base 127 for future use.

Importantly, the embodiment of the invention as illustrated additionally provided an opportunity for achieving a competitive advantage in the marketplace. For example, relying on the internal resource 125 and its collective knowledge base 127 shifts the principal source of requested data from an external source to an internal source, thereby creating an opportunity to develop a proprietary knowledge base. By way of more particular example with reference to the just illustrated example, the corporation 102 may gain advantages over competitors through the analyst from the central resource 125 developing and confirming sales relationships between various regions. These relationships will remain proprietary to the corporation within the central resource collective knowledge base 127, and will be available for relatively quick and low cost use in the future.

The advantages of the disclosed invention are thus attained in an economical, practical, and facile manner. While preferred embodiments and example configurations have been shown and described, it is to be understood that various further modifications and additional configurations will be apparent to those skilled in the art. It is intended that the specific embodiments and configurations herein disclosed are illustrative of the preferred and best modes for practicing the invention, and should not be interpreted as limitations on the scope of the invention as defined by the appended claims.

What is claimed is:

1. A method for continually building a marketing knowledge base within a business organization comprising the steps of:
identifying desired marketing data;
channeling a request for said desired data to a central marketing research resource within the business organization, said central resource having a collective marketing knowledge base; and,
said central resource determining whether said desired data is within said collective marketing knowledge base, and said central resource obtaining said desired data if said data is not within said knowledge base and adding said data to said collective knowledge base.

2. A method as defined by claim 1 wherein the business organization serves a plurality of markets, and wherein said desired marketing data and said collective marketing knowledge base comprise marketing data regarding any of the plurality of markets.

3. A method as defined by claim 1 wherein the business organization has a plurality of business units, and wherein the method further comprises the step of directing substantially all marketing data requests from all of the plurality of business units to said central resource.

4. A method as defined by claim 1 wherein said marketing data comprises quantitative data.

5. A method as defined by claim 1 wherein said step of said central resource obtaining said data comprises said central resource developing said data using an external resource.

6. A method as defined by claim 5 wherein said external resource comprises a marketing consultant, and wherein developing said data comprises having said consultant conduct market research.

7. A method as defined by claim 1 wherein said central resource comprises an analyst group.

8. A method as defined by claim 7 wherein said analyst group comprises a plurality of professional analysts having an average amount of employment with the business organization of at least 5 years.

9. A method as defined by claim 7 wherein said analyst group comprises a plurality of professional analysts and wherein at least one of said professional analysts has a statistical educational background.

10. A method as defined by claim 1 wherein the method further comprises the step of said central resource reporting said desired data if said data is within said knowledge base.

11. A method as defined by claim 1 wherein the method further comprises the step of said central resource determining if only a portion of said desired data is available from said collective knowledge base and if so obtaining the unavailable portion of said desired data from an external resource.

12. A method as defined by claim 1 wherein said collective knowledge base comprises data stored in a combination of written, digital, and human knowledge formats.

13. A method for continually building a marketing knowledge base within a business organization, the business organization of the type that has a plurality of units and that serves a plurality of markets, the method comprising the steps of:
channeling substantially all requests for desired marketing data from all of the plurality of units and for all of the plurality of markets to an analyst group within the business organization, said analyst group comprised of a plurality of professional analysts, at least some of said analysts having at least 5 years experience with the business organization and at least one of said analysts having a statistical educational background, said analyst group having a collective marketing knowledge base;
said analyst group determining whether said desired data requests may be responded to using said collective marketing knowledge base and responding to said request if said collective knowledge base may be used; and,
said analyst group using an external resource to develop said desired data if said data request may not be responded to using said collective marketing knowledge base and adding said desired data to said collective knowledge base whereby said collective knowledge base continually grows.

14. A method for continually building a marketing knowledge base within a business organization, the business organization of the type that has a plurality of units and that serves a plurality of markets, the method comprising the steps of:
channeling substantially all requests for desired marketing data from all of the plurality of units and for all of the plurality of markets to an analyst group within the business organization, said analyst group comprised of a plurality of professional analysts having an average of at least 5 years experience with the business organization and at least some of said analysts having a statistical educational background, said analyst group having a collective marketing knowledge base comprising data stored in digital, written and human knowledge formats;
said analyst group determining whether said collective knowledge base contains all or at least a portion of said requested desired data;
said analyst group obtaining an unavailable portion of said desired data from at least one outside resource if a portion but not all of said desired data is available from said collective knowledge base, said analyst group combining said unavailable portion obtained from said at least one external resource with said available portion form said collective knowledge base to comprise said desired data,
said analyst group obtaining said desired data from at least one external resource if said desired data is not available from said collective knowledge base; and,
said analyst group reporting said desired data.
